(19) United States
(12) Patent Application Publication
(10) Pub. No.: US 2022/0080847 A1
(43) Pub. Date: Mar. 17, 2022

(54) PORTABLE INTELLIGENT CHARGING APPARATUS FOR AN ELECTRICALLY-MOTIVATED PERSONAL TRANSPORTATION DEVICE

(71) Applicant: Hosa Technology, Inc., Buena Park, CA (US)

(72) Inventors: Mayumi Allison, Buena Park, CA (US); Sam Ristich, Los Angeles, CA (US)

(21) Appl. No.: 17/397,763

(22) Filed: Aug. 9, 2021

Related U.S. Application Data
(60) Provisional application No. 63/062,760, filed on Aug. 7, 2020.

(51) Int. Cl. B60L 53/53; B60L 53/34; B60L 53/16; H02J 7/00; H02J 7/34

(52) U.S. Cl. CPC B60L 53/53; B60L 53/34; H02J 7/342; H02J 7/0044; B60L 53/16

(57) ABSTRACT

The present invention relates to a portable intelligent charging apparatus formed from a durable housing having an internal cavity, an internal rechanging pack, a wheel docking port, and a lock.

### FIELD OF THE INVENTION

Embodiments of the invention relates to the field of chargers for electrified vehicles and/or personal mobility devices. More specifically, the invention relates to portable intelligent charging apparatus for an electrically-motivated personal transportation device.

### DESCRIPTION OF THE RELATED ART

Electrified personal transportation devices offer many advantages that improve personal mobility with a minimum of inconvenience. Electrified personal transportation devices have expanded into a variety of forms thanks to improvements in battery technology, electrical motors, control interfaces, and charging interfaces. The wide variety can include electric bicycles, electric scooters, electric skateboards, electric wheel chairs, Segway devices, electric unicycle, electric mopeds, self-balancing electric scooters, Onewheel devices, Walkcar devices, and even electric skates.

Battery-reliant electrical personal transportation devices can require relatively frequent charging to operate in normal service. Frequent charging at charging stations enables each personal transportation devices' on-board energy storage systems to be sized with more certainty, which could lead to reductions in size, mass, and cost of the devices overall. This promotes electric transportation device adoption and use, and thus promotes the benefits associated with the wide-spread adoption of electrified personal transportation devices.

Traditional plug-in charging blocks, power adapters, or elongated cords are not ideal for charging large numbers or groups of individual electric transportation devices simultaneously, as each transportation device would need to either include an on-board intelligent charge management, on-board power adapter, and/or on-board reporting apparatus (thus increasing the cost of each transportation device and thus limiting its advantage as an accessible mode of alternative transportation). This increases cost, while also making the chargers and/or devices inconvenient and unwieldy. The typical recharging frequency means that a manual connection via cord (i.e. physically plugging the transportation device into an available and accessible outlet) is also not ideal.

Traditionally, manually connecting a charger requires the device user to dismount from the device, find a power-supplying plug or outlet for the needed power adapter or charger cord, and then physically carry one or more high voltage cables to the device and plug them in. Distances to power-supplying plugs could be quite far from a user's intended destination, leading to either the need for long lengths of heavy gauge high voltage cable to reach the transportation device under a wider variety of circumstances, or requiring the inconvenience of planning a trip around only where a suitable charging outlet can be found. Even when using a traditional plug or outlet in this way, a user is still required to leave their device alone while charging, thus risking theft or vandalism. A user would thus have to either stay with the device themselves while it charged, or at least carry another bulky piece of equipment to ensure their device is not stolen: a device lock.

Further, it is practically difficult for central leasing or rental companies offering electric personal transportation devices to the buying/renting public to require customers returning rented devices to connect a charging cord to an outlet they need to find themselves, and/or to monitor the charge of each transportation device themselves to ensure that the transportation device maintains a charge and is ready for use. Currently, electric transportation device companies expend a significant amount of money on fleets of employees and/or independent contractors that patrol public areas and gather up electronic transportation devices for charging at a centralized secure location. This solution solves the problem of asking users to inconvenience themselves by finding and carrying out a proper recharge of the device, and the problem of leaving a device vulnerable to theft while charging. However, the problem with the current practice is that it is very time consuming and costly, and requires device rental companies to maintain a very large fleet of transportation devices that can be kept in circulation while allowing others to charge at a costly centralized location. Additionally, charging cords are not usually robust enough to be used widely in public in a variety of locations, and by their nature require a connection to a power source to convey a charge to the connected personal transportation device. These problems further limit accessibility and usability for electric personal transportation devices, and thus diminish their adoption.

Given the problems associated with using charging cords for personal electronic transportation devices, there grew a need for developing discrete and robust electrical charging stations where device users could easily connect their personal transportation devices to charge. Speed of charging at charging stations is also very pertinent for personal electric transportation devices, which may need to be regularly recharged within small time frames to complete their suggested routes or promote their intended usage. In one example, an electric scooter may need to complete a charge in less than ten minutes that is sufficient to enable it to complete a guaranteed operational range, thus ensuring that a scooter rental customer the device would have enough power to operate within its range before having to recharge. Such fast charging and ease-of-use required the construction of robust charging station solutions, or alternatively the use of costly and labor-intensive off-site charging solutions where rental transportation device providers would simply pickup their personal transportation devices on fixed intervals based on an estimated usage and charge state for each device.

The robust nature of these first charging stations meant that they were too large and heavy to be readily transportable or carried by users traveling on their personal transportation devices. Thus, the stations would need to be widely distributed such that device users could travel to a wide variety of locations with the peace-of-mind that they would be able to charge their device at their destination. Additionally, the required ubiquity of charging stations means that maintaining each station separately at a fixed location would lead to high costs for the owners of the stations—government entities, municipalities, landlords, and/or companies renting or selling personal electric transportation devices. These stations also require a fixed connection to a power-source, and a recurring check-and-maintenance schedule where the stations are inspected and approved on-site for their ability to efficiently convey an electrical charge. Finally, these stations also do not secure their electric personal devices in a way such that a user may connect their device to the station securely to prevent theft or use by unauthorized individuals.

There are currently no known systems or devices that overcome the problems and limitations above. There is a need to provide intelligent remotely-manageable electrical charging of vehicles and/or personal transportation devices.

Specifically, a need exists for improved systems and charging apparatuses electrically-motivated personal transportation devices. A further need exists for systems and apparatuses that enable fast charging of electric personal transportation devices at a charging station to enable the electric device to be charged in a minimal amount of time, while charging the electric device to a sufficient level to enable it to operate within its standard operating range. A further need exists for charging systems and apparatuses that allow for remote detection and monitoring of a connected transportation devices' electrical charge, a connected transportation devices' allowable charging current flow, a connected transportation devices' energy storage solution health, a connected transportation devices' location history, a connected transportation devices' electrical firmware version history, and a connected transportation devices' electrical usage history. A further need exists for charging systems and apparatuses that allow for remote monitoring and operation of their electrical charge, charging current flow, internal energy storage solution health, connection to fixed grounded external power source, location, firmware version history, and usage history. The present invention solves these problems.

### DESCRIPTION OF THE DRAWINGS

The above and other aspects, features and advantages of the invention will be more apparent from the following more particular description thereof, presented in conjunction with the following drawings wherein:

FIG. 1 is a perspective view of one embodiment of a portable intelligent charging apparatus for an electrically-motivated personal transportation device.

FIG. 2 is a front view of one embodiment of a portable intelligent charging apparatus for an electrically-motivated personal transportation device.

FIG. 3 is a back view of one embodiment of a portable intelligent charging apparatus for an electrically-motivated personal transportation device.

FIG. 4 is a top view of one embodiment of a portable intelligent charging apparatus for an electrically-motivated personal transportation device.

FIG. 5 is a bottom view of one embodiment of a portable intelligent charging apparatus for an electrically-motivated personal transportation device.

FIG. 6 is a side view of one embodiment of a portable intelligent charging apparatus for an electrically-motivated personal transportation device.

FIG. 7 is a side view cross-section showcasing the internal structure and components of one embodiment of a portable intelligent charging apparatus for an electrically-motivated personal transportation device.

FIG. 8 is a perspective view of another embodiment of a portable intelligent charging apparatus for an electrically-motivated personal transportation device.

FIG. 9 is a side view cross-section showcasing the internal structure and components of another embodiment of a portable intelligent charging apparatus for an electrically-motivated personal transportation device.

### DETAILED DESCRIPTION

The present invention comprising a portable intelligent charging apparatus for an electrically-motivated personal transportation device will now be described. In the following exemplary description numerous specific details are set forth to provide a more thorough understanding of embodiments of the invention. It will be apparent, however, to an artisan of ordinary skill that the present invention may be practiced without incorporating all aspects of the specific details described herein. Furthermore, although steps or processes may be set forth in an exemplary order to provide an understanding of one or more systems and methods, the exemplary order is not meant to be limiting. One of ordinary skill in the art would recognize that such steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

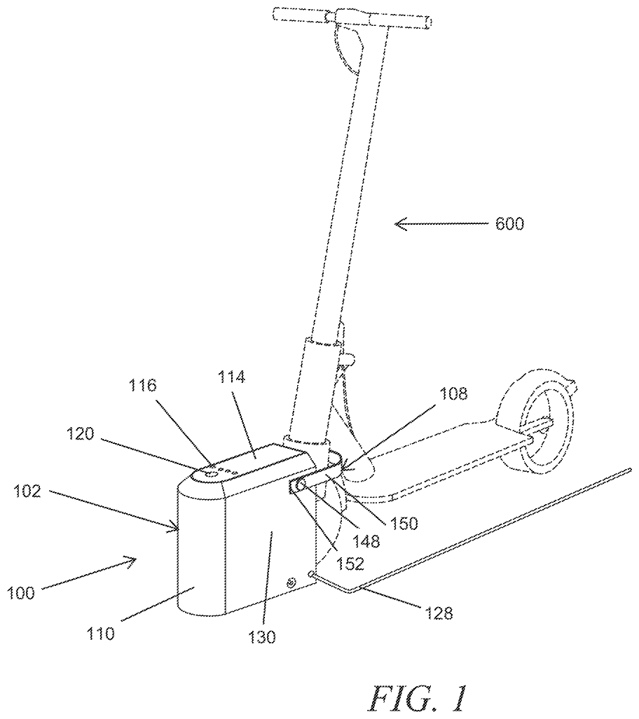

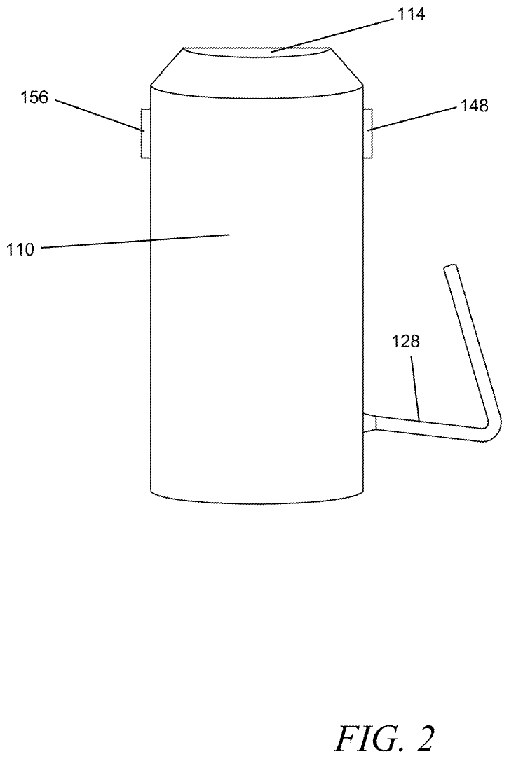

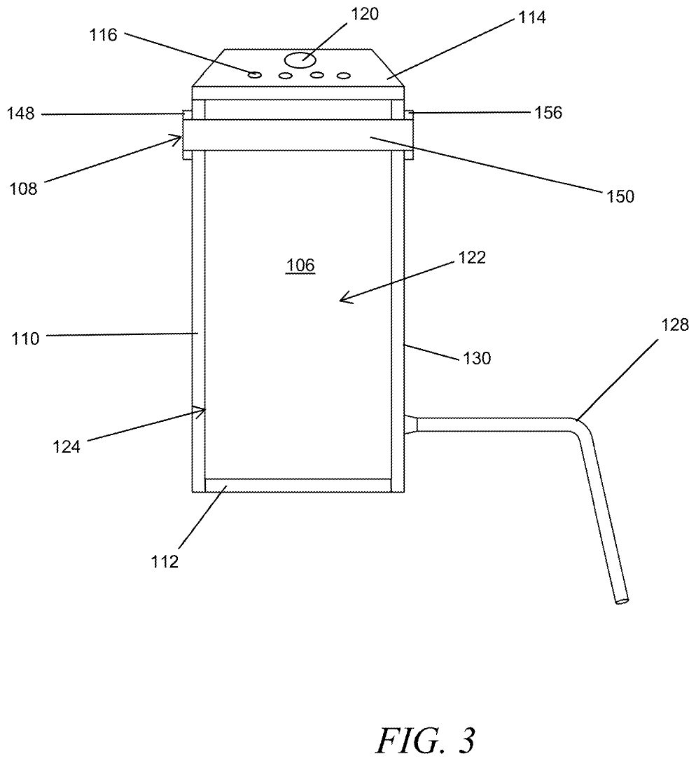

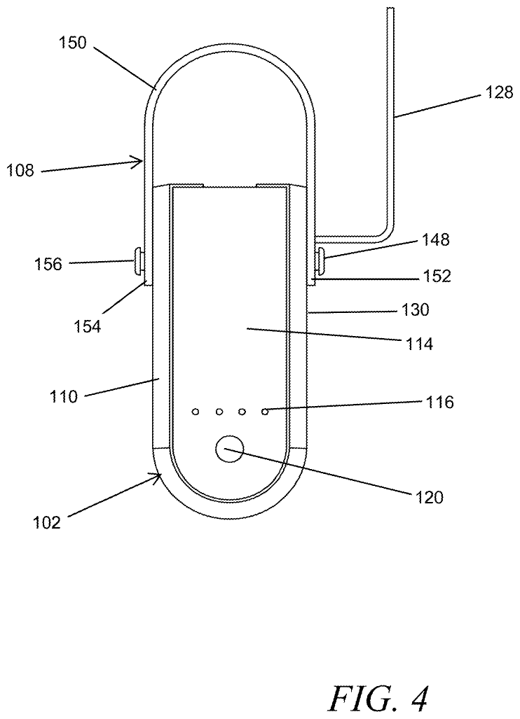

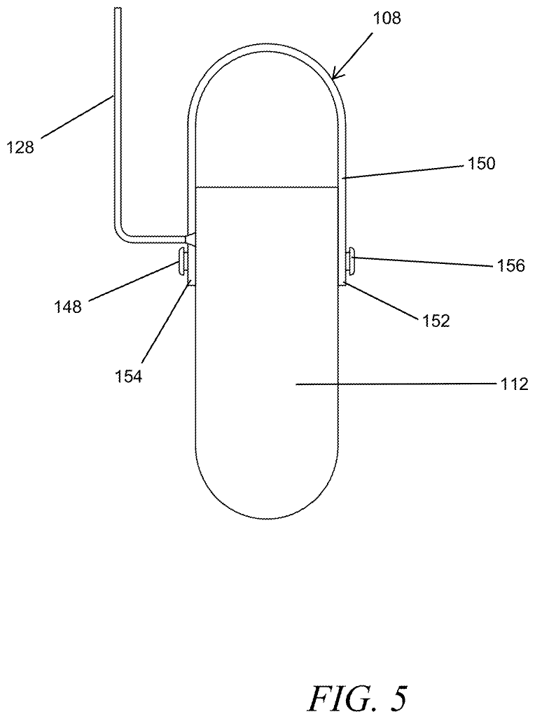

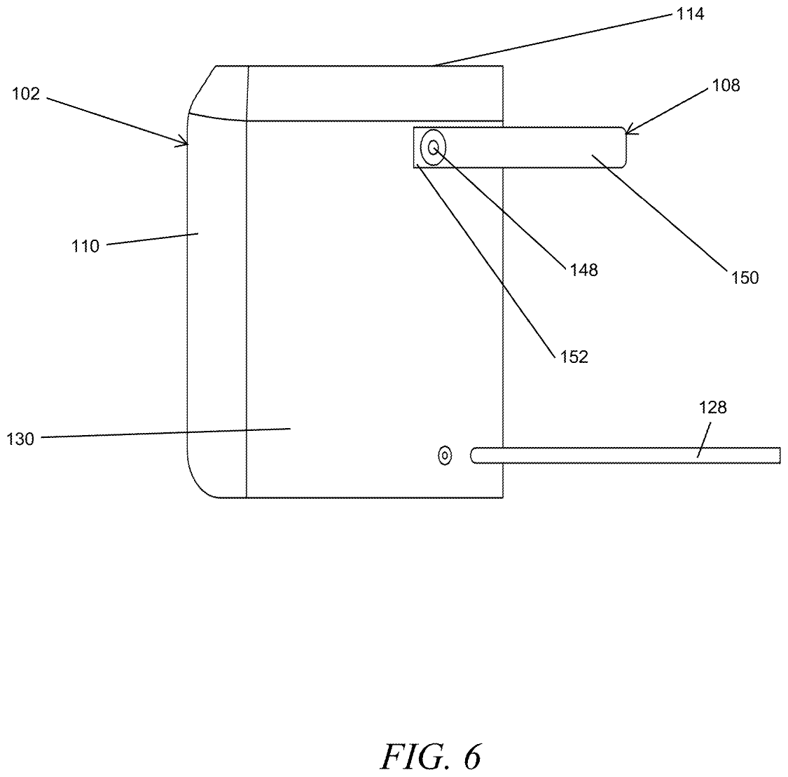

One or more embodiments of the present invention will now be described, in some cases with references to FIGS. 1-6, as they are described above.

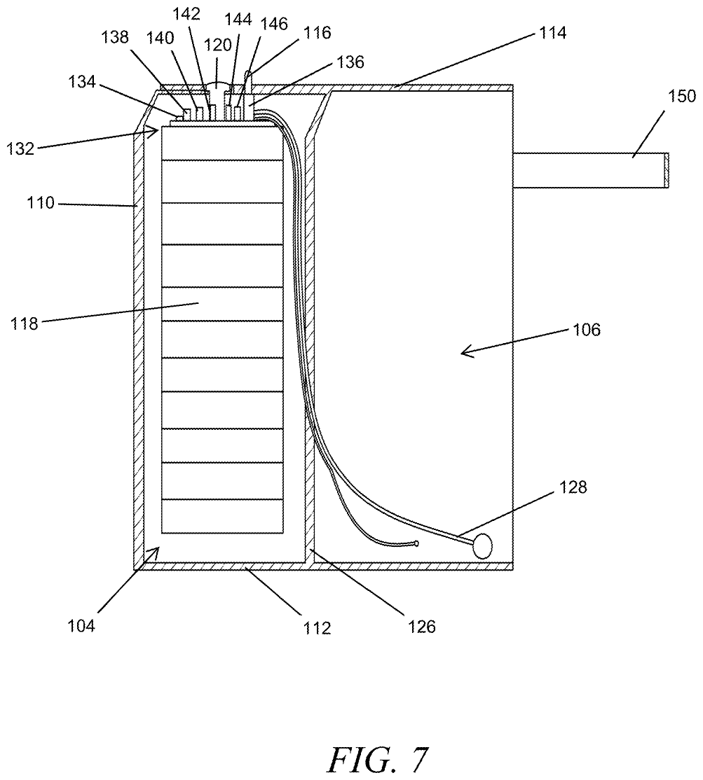

FIGS. 1-7 are illustrations of one embodiment of a portable intelligent charging apparatus 100 for an electrically-motivated personal transportation device 600. This embodiment of a portable intelligent charging apparatus 100 includes a housing 102 having an internal cavity 104, a wheel docking port 106, and a lock 108. The housing is made of a body 110, a bottom surface 112, and a top surface 114. In the embodiment illustrated in FIGS. 1-7, the body 110 is formed by molding or bending a substantially-rectangular piece of durable weather-resistant material approximately at its midpoint around a circular radius to create a component with a substantially “U-shaped” appearance when viewed from the top or bottom. The body 110 is created from a durable weather-resistant material in this embodiment but may be created from any material capable of being shaped or formed to create an internal cavity.

In an alternative embodiment, the housing 102 can be formed form a single piece of durable weather-resistant material comprising a body 110 encompassing the internal cavity 104 alone, without the need for distinct components comprising a substantially flat bottom surface 112 or a top surface 114. In this alternative embodiment, the single-body-piece-housing can be formed via extrusion, injection molding, casting, machining, or printing. In another alternative embodiment, the housing 102 may be formed by only a body 110 piece and a substantially flat bottom surface 112. In another alternative embodiment, the housing 102 may be formed by only a body 110 piece and a top surface 114. In another alternative embodiment, the housing 102 does not include a wheel docking port 106, and instead allows for a lock 108 to secure an electrically-motivated personal transportation device 600 to the housing 102 without shielding or covering a portion of the transportation device 600. The housing 102 securely encloses sensitive electrical and/or computerized equipment within the internal cavity 104 and provides a stable mount for a lock 108 securing an electrically-motivated personal transportation device 600 to the housing 102.

In the embodiments illustrated in FIGS. 1-9, the bottom surface 112 of the housing 102 extends from an edge of said housing 102 opposite a port where a wheel from an electrically-motivated personal transportation device 600 may rest. In an alternative embodiment, the bottom surface 112 need not be substantially flat, and instead may be shaped to better contact a portion of an electrically-motivated personal transportation device 600 connected to the charging apparatus 100. In another alternative embodiment, the bottom surface 112 need not be created from the same material as the body 110 and/or top surface 114, and may also instead be externally coated with a material that enhances the stability of the portable intelligent charging apparatus when deployed upright.

In the embodiments illustrated in FIGS. 1-9, the top surface 114 has a visible multi-light indicator 116 capable of selectively displaying the present charge capacity of at least one rechargeable battery 118 stored within said internal cavity 104, and said top surface 114 having at least one button 120 that activates said visible indicator 116 when contacted by a user. The multi-light indicator 116 may be illuminated in whole, in part, or not at all with the button 120 is activated, to communicate to a user the charge level of the portable intelligent charging apparatus 100 at that moment. In an alternative embodiment, the top surface 114 is not substantially flat, and instead curved to accommodate a portion of an electrically-motivated personal transportation device 600 connected to the charging apparatus 100, or to maximize the space of the internal cavity 114 while allowing the apparatus 100 to maintain a compact footprint. In another alternative embodiment, the top surface 114 is not created from the same material as the body 110 and/or bottom surface 112.

In an alternative embodiment, the visible multi-light indicator 116 is instead replaced with a 2D graphical display (not shown) conveying detailed information including, but not limited to battery capacity, firmware version, battery health, operational history and characteristics, apparatus status, locking status, and/or lock actuation. In conjunction with this alternative graphical display, the button 120 is configured as a binary menu selector, or alternatively replaced with a more complex multi-directional pad and selection actuator to navigate the information and/or menus presented. Additionally, the alternative graphical display may include a protective cover and/or film.

Per the embodiments illustrated in FIGS. 1-9, the housing 102 includes a wheel docking port 106 formed from a space 122 having a substantially-rectangular cross-section created by the parallel extension of the ends of the body 110 to form the elongate sides of the substantially-rectangular port 124, while the top 114 and bottom surfaces 112 to form the short sides of the substantially-rectangular port 124. The body 110, and top 114 and bottom surfaces 112 extend away from a housing wall 126 to create the space 122 in which a wheel would rest when an electrically-motivated personal transportation device 600 is installed. In an alternative embodiment, the wheel docking port 106 has a semicircular or substantially semicircular cross-section. In another alternative embodiment, the wheel docking port 106 has an ovoid or substantially ovoid cross-section. In another alternative embodiment, the wheel docking port 106 has a triangular or substantially triangular cross section.

The housing 102 includes an exterior electrical cable 128 extending outward from an exterior surface 130 of the housing 102 that is connected to at least one rechargeable battery 118 stored within the internal cavity 104. The electrical cable 128 may be used to send charge to an interconnected electrically-motivated personal transportation device 600, or alternatively to send charge to the rechargeable battery 118 stored within the internal cavity 104. In an alternative embodiment, the electrical cable 128 may also convey information to and from computerized components stored within the internal cavity.

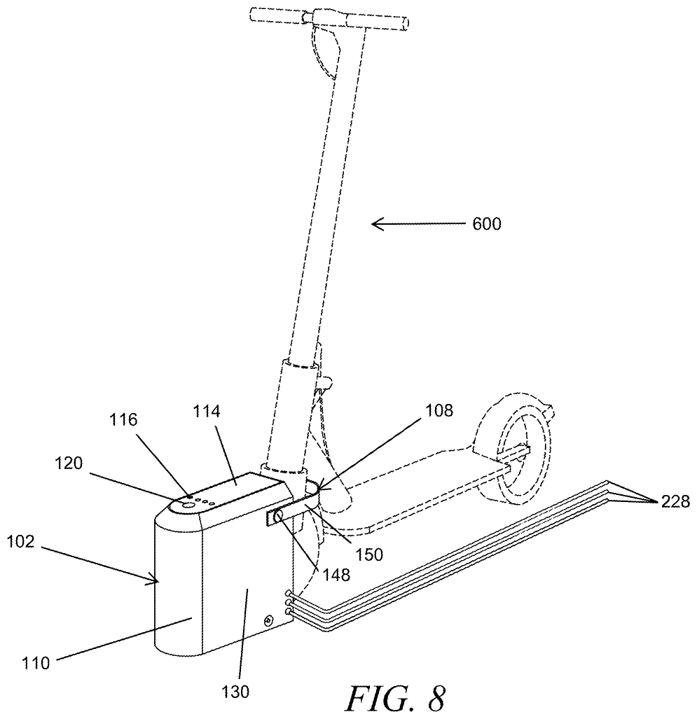

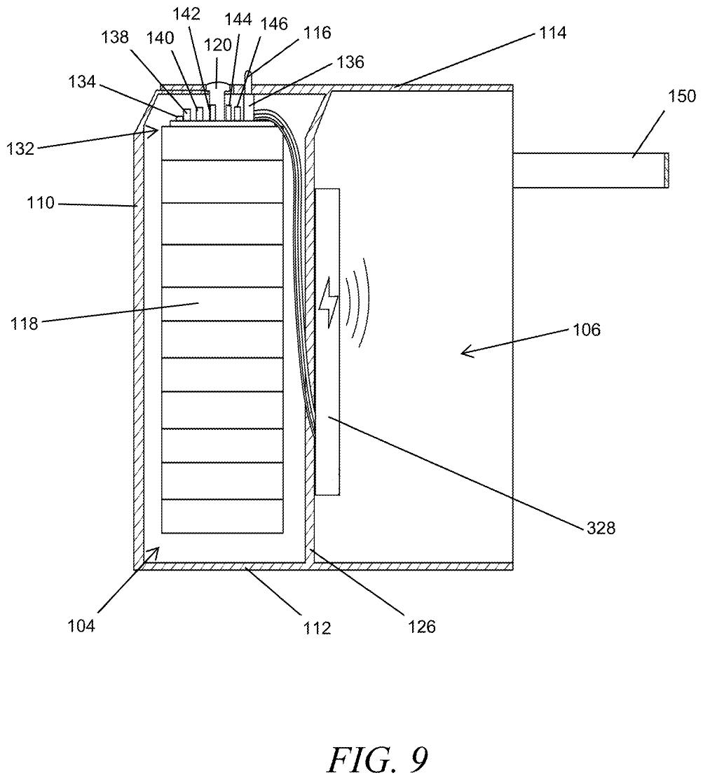

In another alternative embodiment shown in FIG. 8, there may be multiple data and/or electrical cables 228 extending outward from the exterior surface 130 of the housing 102, which could enable simultaneous data communication, transportation device 600 charging, and/or internal rechargeable battery 118 charging. In another alternative embodiment shown in FIG. 9, the housing 102 does not include an exterior cable of any kind, but instead includes a wireless charging transmitter 328 that is connected to at least one rechargeable battery 118 within the internal cavity 104. The wireless charging transmitter 328 could be a near-filed charger or a conductive charger operable such that charging can be accomplished without an external cable, while still maintaining a locking mechanism 108 to prevent device (not shown) theft. The alternative embodiment presented in FIG. 9 also includes wireless data communication with personal electronic transportation device (not shown) on-board systems, such that no wired connection would be required for either charging the device or monitoring and/or controlling the device's systems, battery health, and/or charging status.

In another alternative embodiment, the housing 102 includes a port allowing for the selective attachment of a cable that may also be capable of data communication, transportation device charging, and/or internal rechargeable battery charging.

The body 110, the substantially flat bottom surface 112, the top surface 114, and an internal housing wall 126 are securely joined to seal the internal cavity 104 from unwanted and/or unauthorized access and to prevent the external environment from entering. In alternative embodiments, the internal cavity 104 may be formed solely from the body 110, or in alternative combination with other components. Additionally, the components need not be joined to seal the internal cavity from access or external environmental factors (e.g. dust, liquids, etc.).

Per the embodiments presented at FIGS. 1-7, the internal cavity 104 houses a recharging pack 132 that itself comprises the rechargeable battery 118, the electrical cable 128 in electrical communication with the rechargeable battery, at least one electrical recharging circuit (not shown), a power regulator 134, a computerized controller unit 136, at least one GPS receiver 138, at least one data transceiver 140, at least one current flow sensor 142, at least one batter capacity sensor 144, and at least one battery life sensor 146. The functional operation of the recharging pack 132, and of the charging apparatus 100 entirely, are managed through the computerized controller unit 136, which in one embodiment includes a central processing unit (not shown) and memory (not shown) storing programmed instructions to monitor and manage all other recharging pack 132 components, while simultaneously allowing for remote interconnection via the data transceiver 140. Thus, the computerized controller unit 136 allows remote monitoring and management of current flow (from charger battery 118 to scooter battery, from hardpoint current to charger battery, etc.), overall transportation device 600 battery capacity, and charger/transport battery life. The recharging pack 132 maintains its own charge while also being able to convey a charge to an interconnected personal transportation device 600. In an alternative embodiment, the internal cavity 104 includes more than one recharging pack 132, where each recharging pack 132 may separately interface with external users and/or charge separate personal transportation devices.

In a preferred embodiment, the rechargeable battery 118 is at least one lithium-ion battery cell type having a negative electrode and a positive electrode. In alternative embodiments, the rechargeable battery 118 battery cell types are lithium polymer, lithium iron phosphate, lithium ion manganese oxide, or lithium nickel manganese cobalt oxide. In an alternative embodiment, the rechargeable battery cell type is nickel-metal hydride. In an alternative embodiment, the rechargeable battery cell type is nickel-cadmium. In an alternative embodiment, the rechargeable battery cell type is lead-acid. In an alternative embodiment, the rechargeable battery 118 is of any composition that has a high energy density, little to no memory effect, and little to no self-discharge. In an alternative to the embodiments presented in FIGS. 1-7, the recharging pack 132 may include more than one rechargeable battery 118. In another alternative embodiment, the recharging pack 132 may not include any batteries 118, but instead house an alternative form of energy storage capable of outputting electrical power sufficient to charge an electrically-motivated personal transportation device 600. In another alternative embodiment, the recharging pack 132 may also include an energy generation device, including but not limited to a solar cell, an internal-combustion engine, a kinetic energy recovery system, or a turbine.

The recharging circuit (not shown) is at least in part an electrical circuit that senses and selectively permits unidirectional and/or bidirectional current flows between a power source (e.g. the rechargeable battery 118) and an electrically-motivated personal transportation device 600. In an alternative embodiment, the recharging pack 132 may include more than one recharging circuit (not shown) and connect more than one rechargeable battery 118 to a particular recharging circuit (not shown).

The power regulator 134 is an electrical circuit that automatically senses and maintains a constant power and/or voltage level flowing through the recharging unit 132. The power regulator 134 may be in communicative connection with the computerized control unit 136 and allows for selective control of power and/or voltage by a user. In an alternative embodiment, the power regulator 134 is unchangeable and sets a fixed power and/or voltage level. In an alternative embodiment, there is more than one power regulator 134. In an alternative embodiment, the recharging circuit (not shown) and/or the power regulator 134 are part of a single integrated circuit coupled to the computerized control unit 136.

The computerized control unit 136 is a system comprising an electronic logic circuit and a memory capable of storing programmable instruction sets. The computerized control unit 136 interfaces with all of the other components comprising the recharging pack 132 and is thus able to collect and communicate sensor data, battery capacity data, battery charge amount data, location data, and digitized instructions. The computerized control unit 136 may also be programmed to operate physical locking actuators or open and close power pathways depending on direct user input, or a predefined set of action criteria set by a user. In an alternative embodiment, the computerized control unit 136 also feeds information to a graphical display conveying detailed information embedded within the housing 102.

The GPS receiver 138 is a small electrical subcomponent satellite navigation device capable of receiving information from GNSS satellites and then calculating a resulting geographical position. The GPS receiver 138 may communicate calculated geographical position location data to the computerized control unit 136 on-demand, on a scheduled basis, and/or on an ongoing basis.

The data transceiver 140 is a wireless electrical communication circuit module communicatively connected to the computerized control unit 136. The data transceiver 140 allows for wireless communication between at least one remote user or server and the computerized control unit 136, such that data collected by the control unit 136 is conveyed to the user and instructions from the user are conveyed to the control unit 136. The data transceiver 140 may operate on a variety of radio frequencies and/or wireless networking technologies, including but not limited to cellular band (3G, 4G, 4G LTE, 5G, etc.), Wi-Fi, NFC, and Bluetooth. In an alternative embodiment, the data transceiver 140 is a physical data interface and port for direct wired electrical connection to the computerized control unit 136.

Per the embodiments illustrated in FIGS. 1-7, the current flow sensor 142 is an electrical device that senses a value of the electrical current flowing through the recharging unit 132 and transmits that value to the computerized control unit 136. In an alternative embodiment, the current flow sensor 142 may be embedded within the power regulator 134 and/or recharging circuit (not shown) and may be incorporated into an embedded circuit with the computerized control unit 136 itself. The battery capacity sensor 144 is an electrical device that senses the amount of charge currently within the at least one rechargeable battery 118. The batter life sensor 146 is an electrical device that monitors the resistivity of the rechargeable battery 118 and recharging circuit (not shown) to detect the total remaining capacity of the rechargeable battery 118. In an alternative embodiment, the battery capacity sensor 144 and/or battery life sensor 146 are not included within the recharging pack 132, and instead power, current, and resistivity data is collected by the recharging circuit (not shown) and/or power regulator 134, and sent to the computerized control unit 136. In another alternative embodiment, the battery capacity sensor 144 and/or battery life sensor 146 are not included within the recharging pack 132, and instead the computerized control unit 136 directly determines the capacity of the rechargeable battery 118 and/or its remaining total capacity.

In an alternative embodiment, the recharging pack 132 may include a fluid-reliant cooling system (not shown) that maintains all electrical components at an optimal temperature within the internal cavity 104. In another alternative embodiment, the recharging pack 132 may include fault sensors that detect ground and/or electrical faults and may selectively limit or cease power transfers, or limit or restrict use of the charging apparatus 100 altogether.

Per the embodiments illustrated in FIGS. 1-7, the lock 108 securely and selectively couples the portable intelligent charging apparatus 100 to an electrically-motivated personal transportation device 600. The lock 108 includes an anchor 148 fixed to an exterior surface 130 of the charging apparatus body 110, a selectively-movable shackle 150 with a first shackle end 152 affixed to said anchor 148 and a second locking end 154 selectively attached to a selectively-actuatable locking mechanism 156, and wherein the selectively-actuatable locking mechanism 156 is fixed to a second exterior surface 158 of the charging apparatus body 110. In this embodiment, the selectively-actuatable locking mechanism 156 is a mechanically-actuating rotating tumbler lock openable with a physical key.

In an alternative embodiment, the selectively-actuatable locking mechanism 156 is an electronic lock having a state sensor and electric actuator that are communicatively coupled to the computerized control unit 136, such that the computerized control unit 136—via the data transceiver 140—allows for the remote actuation of the selectively-actuatable locking mechanism 156. In another alternative embodiment, the selectively-actuatable locking mechanism 156 is a mechanically-actuating lock openable following the correct input of alphanumeric characters or values.

While the invention herein disclosed has been described by means of specific embodiments and applications thereof, numerous modifications and variations could be made thereto by those skilled in the art without departing from the scope of the invention as-disclosed.

What is claimed is:

1. A portable charging apparatus for a transportation device, the apparatus comprising:
a housing having an internal cavity, a wheel docking port, and a lock;
wherein said internal cavity houses a recharging pack, said recharging pack comprising:
at least one rechargeable battery, at least one electrical cable in electrical communication with said at least one rechargeable battery, at least one electrical recharging circuit, a power regulator, a computerized controller, at least one GPS transceiver, at least one data transceiver, at least one current flow sensor, at least one batter capacity sensor, and at least one battery life sensor, and wherein said internal cavity is sealed against liquid intrusion;
and wherein said lock comprises an anchor fixed to a first exterior surface of said housing, a movable locking mechanism fixed to a second exterior surface of said housing, a movable shackle having a first shackle end affixed to said anchor, and a second locking end selectively attached to said movable locking mechanism,
and wherein said movable locking mechanism includes an electronic lock having a sensor and that is communicatively coupled to said computerized controller.

2. The portable charging apparatus of claim 1, wherein said housing is comprised of a durable metallic weather-resistant material.

3. The portable charging apparatus of claim 1, wherein said housing is formed from a body, a substantially flat bottom surface extending from an edge of said housing opposite said wheel docking port, into said wheel docking port such that a wheel from said transportation device rests on an exposed upper surface of said substantially flat bottom surface when inserted into said wheel docking port, and a top surface having at least one visible indicator displaying the capacity of the at least one rechargeable battery stored within said internal cavity.

4. The portable charging apparatus of claim 3, wherein said top surface includes at least one button that selectively activates said visible indicator when operated by a user.

5. The portable charging apparatus of claim 3, wherein said internal cavity is formed from a volume created by the joining of said body, said substantially flat bottom surface, said top surface, and a housing wall.

6. The portable charging apparatus of claim 1, wherein said wheel docking port is formed from said body, said top surface, said substantially flat bottom surface, and an opening opposite said internal cavity.

7. The portable charging apparatus of claim 1, wherein said electrical cable exits from said internal cavity through an exterior surface of said housing.

8. A portable charging apparatus for a transportation device, the apparatus comprising:
a housing having at least one wireless charging transmitter, an internal cavity, a wheel docking port, and a lock;
wherein said internal cavity houses a recharging pack, said recharging pack comprising:
at least one rechargeable battery, at least one electrical cable in electrical communication with said at least one rechargeable battery and said wireless charging transmitter, at least one electrical recharging circuit, a power regulator, a computerized controller, at least one GPS transceiver, at least one data transceiver, at least one current flow sensor, at least one batter capacity sensor, and at least one battery life sensor, and wherein said internal cavity is sealed against liquid intrusion;
and wherein said lock comprises an anchor fixed to a first exterior surface of said housing, a movable locking mechanism fixed to a second exterior surface of said housing, a movable shackle having a first shackle end affixed to said anchor, and a second locking end selectively attached to said movable locking mechanism,
and wherein said movable locking mechanism includes an electronic lock having a sensor and that is communicatively coupled to said computerized controller.

9. The portable charging apparatus of claim 8, wherein said housing is comprised of a durable metallic weather-resistant material.

10. The portable charging apparatus of claim 8, wherein said housing is formed from a body, a substantially flat bottom surface extending from an edge of said housing opposite said wheel docking port, into said wheel docking port such that a wheel from said transportation device rests on an exposed upper surface of said substantially flat bottom surface when inserted into said wheel docking port, and a top surface having at least one visible indicator displaying the capacity of the at least one rechargeable battery stored within said internal cavity.

11. The portable charging apparatus of claim 10, wherein said top surface includes at least one button that selectively activates said visible indicator when operated by a user.

12. The portable charging apparatus of claim 10, wherein said internal cavity is formed from a volume created by the joining of said body, said substantially flat bottom surface, said top surface, and a housing wall.

13. The portable charging apparatus of claim 8, wherein said wheel docking port is formed from said body, said top surface, said substantially flat bottom surface, and an opening opposite said internal cavity.
